(19) United States
(12) Patent Application Publication
(10) Pub. No.: US 2011/0029506 A1
(43) Pub. Date: Feb. 3, 2011

(54) METHOD AND APPARATUS FOR BOUNDING LARGE QUERY OPERATIONS

(75) Inventors: Dan Prescott, Colorado Springs, CO (US); Bob Vogt, Colorado Springs, CO (US); John Monk, Colorado Springs, CO (US)

Correspondence Address: PATENTTM.US, P. O. BOX 82788, PORTLAND, OR, 97282-0788, US

(73) Assignee: FLUKE CORPORATION, Everett, WA (US)

(21) Appl. No.: 12/538,790

(22) Filed: Aug. 10, 2009

Related U.S. Application Data
(60) Provisional application No. 61/229,176, filed on Jul. 28, 2009.

(51) Int. Cl. G06F 17/30; G06F 15/16

(52) U.S. Cl. 707/713; 709/224; 707/E17.017

(57) ABSTRACT

Bounding of large queries is provided in a network analysis environment by receiving a user query of a data set of network transactions, submitting a meta data query to the data set to determine whether the query would require an unreasonable amount of time to complete, and notifying the user to re-formulate the query if it would require too much time.

### CROSS-REFERENCE TO RELATED APPLICATIONS

This application claims priority of U.S. provisional patent application 61/229,176, filed Jul. 28, 2009, entitled METHOD AND APPARATUS FOR BOUNDING LARGE QUERY OPERATIONS.

### BACKGROUND OF THE INVENTION

This invention relates to networking analysis, and more particularly to a method and apparatus for bounding large query operations, to alert a user of a network test system that a data set query may be too large to complete in a reasonable time.

In test and measurement of complex computer networking environments, one system of network analysis operates by monitoring network traffic and collecting and storing data related to the network traffic for later analysis and presentation. Typically many hundreds of gigabytes of data will be collected.

A network technician using a test and measurement system of this type may submit queries to the system in the process of analyzing the network data. However, a complex query or a query on a specific set of data may be of such computational complexity that given the large amount of data, the query may require a substantial amount of time to complete. If the amount of time is too long, the technician may become frustrated or give up while waiting for results to be returned. It should be noted that the term “too long” is a subjective measure of the technician or other user's perception of the amount of time from the submission of the query to the results being returned back to the user.

### SUMMARY OF THE INVENTION

In accordance with the invention, a query is employed to conduct a meta data query to provide a determination of the size of the desired query result set. If the result set is too large, an information, warning, or error message is returned to the user. Otherwise, the desired query is submitted to the data set in order to determine and supply the results to the user.

Accordingly, it is an object of the present invention to provide an improved network analysis system for determining whether a query result set is too large to complete in a reasonable amount of time and warning the user if it is too large.

It is a further object of the present invention to provide a system for bounding large queries of network data.

It is yet another object of the present invention to provide improved methods of performing network data set queries.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a diagram of a network operation in accordance with the query bounding system;

FIG. 2 is a flow chart of operational steps for bounding large query operations; and

FIG. 3 is a flow chart of alternate operational steps for bounding large query operations.

### DETAILED DESCRIPTION

The system according to a preferred embodiment of the present invention comprises a monitoring system and method having interface for the user to query a network data set and for determining whether the query would or would not execute in a reasonable time.

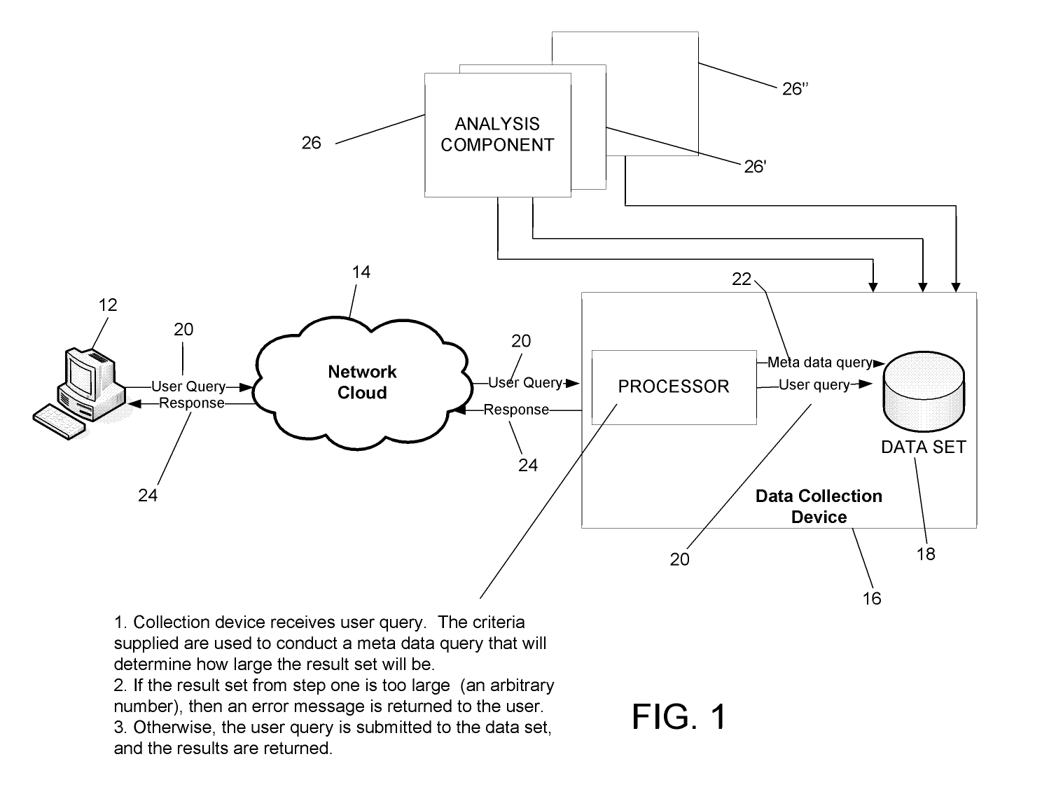

Referring to FIG. 1, a diagram of a network operation in accordance with the query bounding system, a user's computer 12 is connected via network cloud 14 to a data collection device 16. Data collection device 16 includes a data set 18 that contains collected network data that the data collection device has stored from monitoring the network over a period of time. The monitoring may be performed by one or more analysis components or monitoring systems 26, 26′, 26″, etc. that may be positioned within the network to store information about said network.

The data set 18 may include data comprising a collection that describes parts of conversations between points in the network (or networks) that are monitored, information metrics, measured network parameters and operational details and information about events and transactions observed during monitoring.

In operation, the user logs into an interface to the data collection device to submit a query 20 to the data collection device 16. The data collection device includes a processor that receives the user query and submits a meta data query 22 to the data set. Among other items collected in the data set are information, statistics or other data regarding the network traffic. An example of such information, etc. is the number of transactions between a client and a server. Accordingly, the device 16 processor submits a meta data query to the data set to determine, for example, the number of transactions in the data set between client and server. If the number of transactions is too large such that the amount of time to perform a search or analysis of the data would not be reasonable, then a response indication 24 from the device 16 is returned to the user indicating that the search needs to be refined.

If the determination is that the query is reasonable with respect to the amount of data that would be searched and accordingly the amount of time to complete the query, then the user query is submitted to the data set for selection of the data and return of the results.

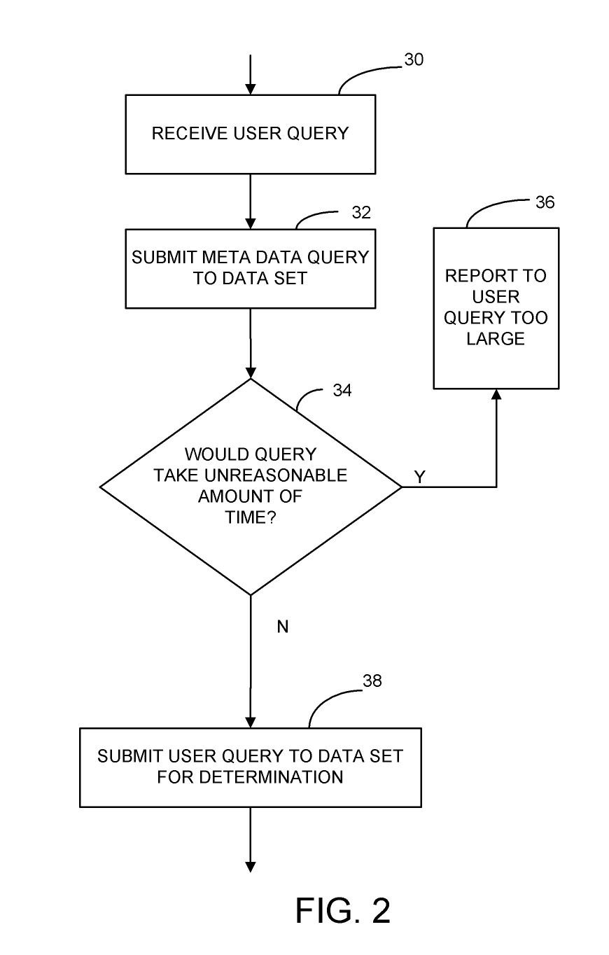

FIG. 2 is a flow chart illustrating the steps of bounding large query operations, wherein the user query is received (block 30) and a meta data query is submitted to the data set (block 32) to determine whether the query would be completed in a reasonable amount of time, based on information about the network traffic. If the decision (block 34) is that the query would be too large and would take an unreasonable amount of time, then an information, warning, or error message is sent to the user (block 36). If the determination in block 34 is that the query would complete in a reasonable amount of time, then the user query is submitted to the data set for determination of results (block 38).

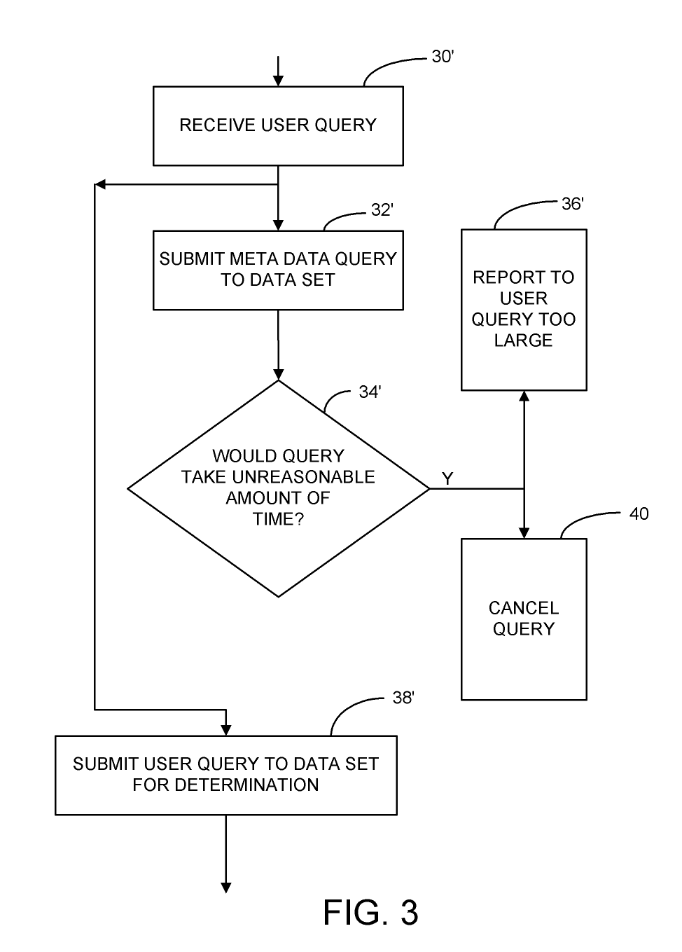

FIG. 3 illustrates an alternate operation, wherein the query of the data set and the and meta data query may be made concurrently or substantially concurrently, wherein the user query is received (block 30′) and is submitted to the data set for consideration and also, concurrently a meta data query is submitted to the data set (block 32′) to determine whether the query would be completed in a reasonable amount of time, based on information about the network traffic. If the decision (block 34′) is that the query would be too large and would take an unreasonable amount of time, then an information, warning, or error message is sent to the user (block 36′) and the user query is canceled (block 40). If the determination in block 34′ is that the query would complete in a reasonable amount of time, then no further action need be taken as the user query was already submitted for determination. An advantage of this alternative operation is that the query of the data set is begun as soon as possible which may allow quicker results for the user when the meta data query determination is that the query should proceed, rather than waiting for the meta data query determination to complete.

As an example of operation of the device and method, in a network analysis environment, a query might be a request for all the transactions that conform to some filter criteria, all transactions from a time period, all transactions from a particular server or servers, all transactions between a particular server or servers and client(s), etc. Such queries could result in looking at millions or more of transactions, which could lead to unreasonable computation time or result sets.

Consequently, the system determines whether a query from a user can be quickly retrieved in a reasonable amount of time, which in a particular embodiment is chosen to be within 5 minutes.

Other data sets could include packet data, client statistical data, server statistical data, a set where all elements are greater than some threshold on one specific metric, etc.

In accordance with the above, the invention employs a meta data search to determine whether a user query can be completed within a reasonable time, and advises a user if the results would take an unreasonable amount of time to return. This allows the user to submit a more reasonable search criteria to obtain meaningful results, reducing the likelihood of user frustration as would occur from long delays before the user realized the criteria was too computationally complex to provide results in a reasonable time.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A method of bounding large query operations in a network analysis device, comprising:
receiving a query from a user;
determining if the query would require an unreasonable amount of time to complete; and
if the determining is that the query would require an unreasonable amount of time, notifying the user.

2. The method according to claim 1, wherein if the determination is that the query would not require an unreasonable amount of time, submitting the user query for completion.

3. The method according to claim 1, wherein an unreasonable amount of time is greater than 5 minutes.

4. The method according to claim 1, wherein said query is a query of a network transactions data set.

5. The method according to claim 1, wherein said determining if the query would require an unreasonable amount of time comprises submitting a meta data query.

6. The method according to claim 5, wherein said meta data query comprises a query of a number of network transactions that would be involved in the query.

7. The method according to claim 1, further comprising submitting the user query for completion.

8. The method according to claim 7, wherein said submitting the user query for completion is performed concurrently with determining if the query would require an unreasonable amount of time to complete.

9. The method according to claim 8, wherein if a determination is that the query would require an unreasonable amount of time to complete, canceling the user query that had been submitted for completion.

10. A system for bounding large query operations in a network analysis device, comprising:
at least one device for collecting data about network transactions;
a data collection device including a data set storing data based from collected data from said at least one network device;
said data collection device including a processor adapted for receiving a query from a user,
said processor determining if the query would require an unreasonable amount of time to complete; and
if the determining is that the query would require an unreasonable amount of time, said processor providing information for notifying the user of the determination.

11. The system according to claim 10, wherein if the determination is that the query would not require an unreasonable amount of time, said processor submits the user query for completion.

12. The system according to claim 10, wherein an unreasonable amount of time is greater than 5 minutes.

13. The system according to claim 10, wherein said query is a query of a network transactions data set.

14. The system according to claim 10, wherein said processor submits the user query for completion concurrently with beginning the determination of whether the query would require an unreasonable amount of time, and if the determination is that the query would require an unreasonable amount of time, said processor cancels the user query.

15. A network analysis system for analyzing a network and providing bounding of large query operations, comprising:
plural network analysis components interfaced with the network for monitoring network traffic and providing monitored information for storing in a data set; and
a data collection device for receiving a user query of the data set and performing a meta data query of the data set to determine whether completion of the query would take longer than a specified amount of time.

16. The network analysis system according to claim 15, wherein if said data collection device determines that the query would require longer than the specified amount of time, said data collection device notifies the user of the determination.

17. The network analysis system according to claim 15, if said data collection device determines that the query would not require longer than the specified amount of time, said data collection device submits the user query for completion.

18. The system according to claim 15, wherein the specified amount of time is greater than 5 minutes.
